(19) United States
(12) Patent Application Publication
(10) Pub. No.: US 2019/0182020 A1
(43) Pub. Date: Jun. 13, 2019

(54) RELIABLE LOW LATENCY OPERATIONS IN TIME DIVISION DUPLEX WIRELESS COMMUNICATION SYSTEMS

(71) Applicant: QUALCOMM Incorporated, San Diego, CA (US)

(72) Inventors: Shimman Arvind PATEL, San Diego, CA (US); Seyedkianoush HOSSEINI, San Diego, CA (US); Wanshi CHEN, San Diego, CA (US)

(21) Appl. No.: 16/214,909

(22) Filed: Dec. 10, 2018

Related U.S. Application Data
(60) Provisional application No. 62/598,271, filed on Dec. 13, 2017.

(51) Int. Cl. H04L 5/14; H04W 72/08; H04W 24/08; H04L 5/00; H04W 72/04; H04W 76/27

(52) U.S. Cl. CPC H04L 5/1469; H04W 72/085; H04W 76/27; H04L 5/0055; H04W 72/042; H04W 24/08

(57) ABSTRACT

Various aspects of the present disclosure generally relate to wireless communication. In some aspects, a receiving device may determine an uplink-downlink time division duplex (TDD) shortened transmission time interval (sTTI) configuration; determine an initial sTTI, within the uplink-downlink TDD sTTI configuration, for reception of an initial communication; and monitor one or more sTTIs, subsequent to the initial sTTI, for reception of at least one repetition or retransmission of the initial communication, wherein the one or more sTTIs are determined based at least in part on a pattern associated with the uplink-downlink TDD sTTI configuration. Numerous other aspects are provided.

### CROSS-REFERENCE TO RELATED APPLICATIONS UNDER 35 U.S.C. § 119

This application claims priority to U.S. Provisional Patent Application No. 62/598,271, filed on Dec. 13, 2017, entitled “TECHNIQUES AND APPARATUSES FOR RELIABLE LOW LATENCY OPERATIONS IN TIME DIVISION DUPLEX WIRELESS COMMUNICATION SYSTEMS,” which is hereby expressly incorporated by reference herein.

### FIELD OF THE DISCLOSURE

Aspects of the present disclosure generally relate to wireless communication, and more particularly to techniques and apparatuses for reliable low latency operations in time division duplex (TDD) wireless communication systems.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless communication network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a new radio (NR) BS, a 5G Node B, and/or the like.

The above multiple access technologies have been adopted in various telecommunication standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. However, as the demand for mobile broadband access continues to increase, there exists a need for further improvements in LTE and NR technologies. Preferably, these improvements should be applicable to other multiple access technologies and the telecommunication standards that employ these technologies.

### SUMMARY

In some aspects, a method of wireless communication, performed by a receiving device operating in a low latency mode or a high reliability mode, may include determining an uplink-downlink time division duplex (TDD) shortened transmission time interval (sTTI) configuration; determining an initial sTTI, within the uplink-downlink TDD sTTI configuration, for reception of an initial communication; and monitoring one or more sTTIs, subsequent to the initial sTTI, for reception of at least one repetition or retransmission of the initial communication, wherein the one or more sTTIs are determined based at least in part on a pattern associated with the uplink-downlink TDD sTTI configuration.

In some aspects, a method of wireless communication, performed by a transmitting device operating in a low latency mode or a high reliability mode, may include determining an uplink-downlink time division duplex (TDD) shortened transmission time interval (sTTI) configuration; determining an initial sTTI, within the uplink-downlink TDD sTTI configuration, for transmission of an initial communication; and transmitting at least one repetition or retransmission of the initial communication in one or more sTTIs subsequent to the initial sTTI, wherein the one or more sTTIs are determined based at least in part on a pattern associated with the uplink-downlink TDD sTTI configuration.

In some aspects, a receiving device for wireless communication may include memory and one or more processors coupled to the memory. The memory and the one or more processors may be configured to determine an uplink-downlink time division duplex (TDD) shortened transmission time interval (sTTI) configuration; determine an initial sTTI, within the uplink-downlink TDD sTTI configuration, for reception of an initial communication; and monitor one or more sTTIs, subsequent to the initial sTTI, for reception of at least one repetition or retransmission of the initial communication, wherein the one or more sTTIs are determined based at least in part on a pattern associated with the uplink-downlink TDD sTTI configuration.

In some aspects, a transmitting device for wireless communication may include memory and one or more processors coupled to the memory. The memory and the one or more processors may be configured to determine an uplink-downlink time division duplex (TDD) shortened transmission time interval (sTTI) configuration; determine an initial sTTI, within the uplink-downlink TDD sTTI configuration, for transmission of an initial communication; and transmit at least one repetition or retransmission of the initial communication in one or more sTTIs subsequent to the initial sTTI, wherein the one or more sTTIs are determined based at least in part on a pattern associated with the uplink-downlink TDD sTTI configuration.

In some aspects, a non-transitory computer-readable medium may store one or more instructions for wireless communication. The one or more instructions, when executed by one or more processors of a receiving device, may cause the one or more processors to determine an uplink-downlink time division duplex (TDD) shortened transmission time interval (sTTI) configuration; determine an initial sTTI, within the uplink-downlink TDD sTTI configuration, for reception of an initial communication; and monitor one or more sTTIs, subsequent to the initial sTTI, for reception of at least one repetition or retransmission of the initial communication, wherein the one or more sTTIs are determined based at least in part on a pattern associated with the uplink-downlink TDD sTTI configuration.

In some aspects, a non-transitory computer-readable medium may store one or more instructions for wireless communication. The one or more instructions, when executed by one or more processors of a transmitting device, may cause the one or more processors to determine an uplink-downlink time division duplex (TDD) shortened transmission time interval (sTTI) configuration; determine an initial sTTI, within the uplink-downlink TDD sTTI configuration, for transmission of an initial communication; and transmit at least one repetition or retransmission of the initial communication in one or more sTTIs subsequent to the initial sTTI, wherein the one or more sTTIs are determined based at least in part on a pattern associated with the uplink-downlink TDD sTTI configuration.

In some aspects, an apparatus for wireless communication may include means for determining an uplink-downlink time division duplex (TDD) shortened transmission time interval (sTTI) configuration; means for determining an initial sTTI, within the uplink-downlink TDD sTTI configuration, for reception of an initial communication; and means for monitoring one or more sTTIs, subsequent to the initial sTTI, for reception of at least one repetition or retransmission of the initial communication, wherein the one or more sTTIs are determined based at least in part on a pattern associated with the uplink-downlink TDD sTTI configuration.

In some aspects, an apparatus for wireless communication may include means for determining an uplink-downlink time division duplex (TDD) shortened transmission time interval (sTTI) configuration; means for determining an initial sTTI, within the uplink-downlink TDD sTTI configuration, for transmission of an initial communication; and means for transmitting at least one repetition or retransmission of the initial communication in one or more sTTIs subsequent to the initial sTTI, wherein the one or more sTTIs are determined based at least in part on a pattern associated with the uplink-downlink TDD sTTI configuration.

Aspects generally include a method, device, apparatus, system, computer program product, non-transitory computer-readable medium, user equipment, base station, receiving device, transmitting device, wireless communication device, and processing system as substantially described herein with reference to and as illustrated by the accompanying drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communication network, in accordance with various aspects of the present disclosure.

FIG. 2 is a block diagram conceptually illustrating an example of a base station in communication with a user equipment (UE) in a wireless communication network, in accordance with various aspects of the present disclosure.

FIG. 3 is a block diagram conceptually illustrating an example of a frame structure in a wireless communication network, in accordance with various aspects of the present disclosure.

FIGS. 4-10 are diagrams illustrating examples relating to reliable low latency operations in time division duplex (TDD) wireless communication systems, in accordance with various aspects of the present disclosure.

FIG. 11 is a diagram illustrating an example process performed, for example, by a receiving device, in accordance with various aspects of the present disclosure.

FIG. 12 is a diagram illustrating an example process performed, for example, by a transmitting device, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented, or a method may be practiced, using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with 3G and/or 4G wireless technologies, aspects of the present disclosure can be applied in other generation-based communication systems, such as 5G and later, including NR technologies.

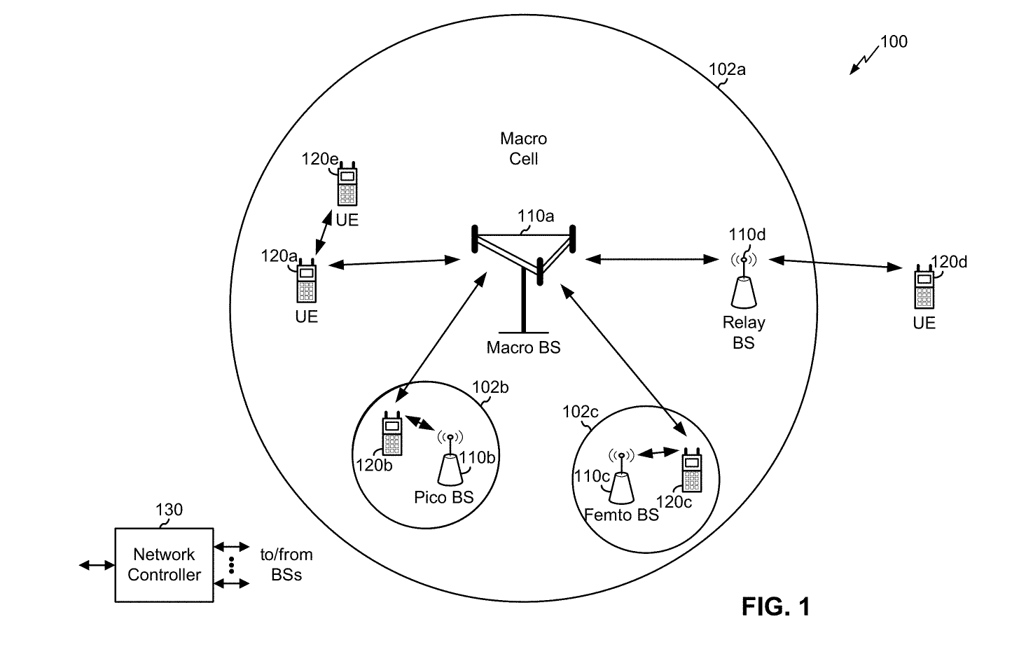

FIG. 1 is a diagram illustrating a network 100 in which aspects of the present disclosure may be practiced. The network 100 may be an LTE network or some other wireless network, such as a 5G or NR network. Wireless network 100 may include a number of BSs 110 (shown as BS 110a, BS 110b, BS 110c, and BS 110d) and other network entities. A BS is an entity that communicates with user equipment (UEs) and may also be referred to as a base station, a NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. ABS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. ABS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the access network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communication between BS 110a and UE 120d. A relay station may also be referred to as a relay BS, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 Watts) whereas pico BSs, femto BSs, and relay BSs may have lower transmit power levels (e.g., 0.1 to 2 Watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, such as sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as may be implemented as NB-IoT (narrowband internet of things) devices. Some UEs may be considered a Customer Premises Equipment (CPE). UE 120 may be included inside a housing that houses components of UE 120, such as processor components, memory components, and/or the like.

In general, any number of wireless networks may be deployed in a given geographic area. Each wireless network may support a particular RAT and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

In some aspects, UE 120 and/or base station 110 may operate in a low latency mode that is associated with a latency requirement, and/or may operate in a high reliability mode that is associated with a reliability requirement. For example, UE 120 and/or base station 110 may operate in an ultra-reliable low latency communication (URLLC) mode. The URLLC mode may be associated with, for example, a 1 ms latency requirement for sending a 32 byte packet with a transmission error rate of less than 10⁻⁵, a 10 ms latency requirement for sending a 32 byte packet with a transmission error rate of less than 10⁻⁵, or another latency requirement for sending a packet of a particular size with a transmission error rate that is less than a threshold.

As indicated above, FIG. 1 is provided as an example. Other examples may differ from what is described with regard to FIG. 1.

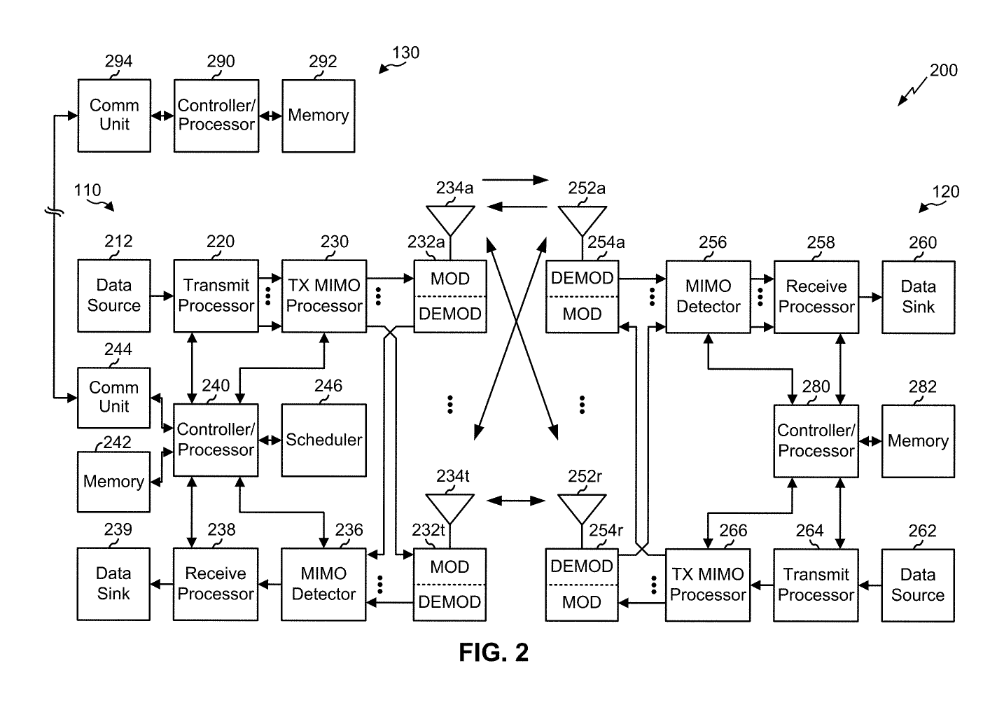

FIG. 2 shows a block diagram of a design of base station 110 and UE 120, which may be one of the base stations and one of the UEs in FIG. 1. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 120, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Network controller 130 may include communication unit 294, controller/processor 290, and memory 292.

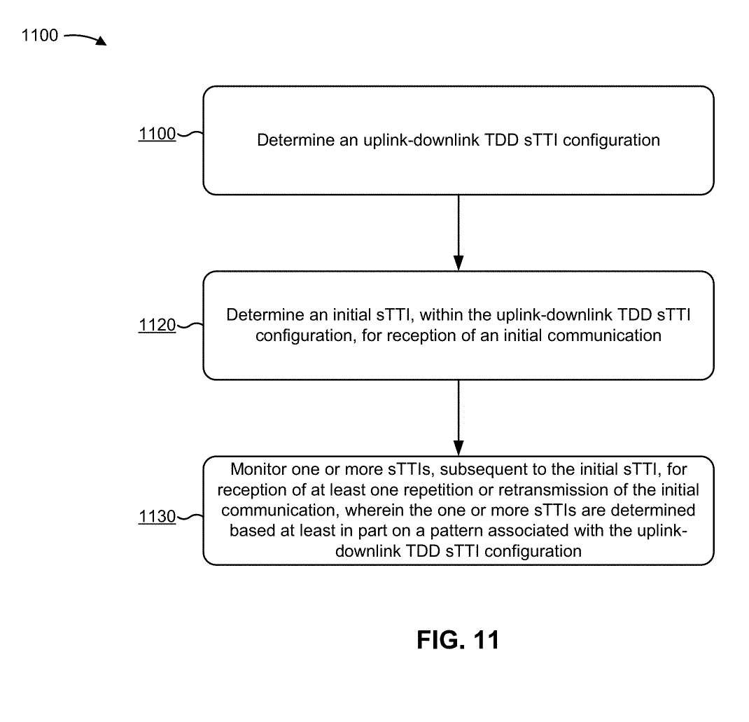

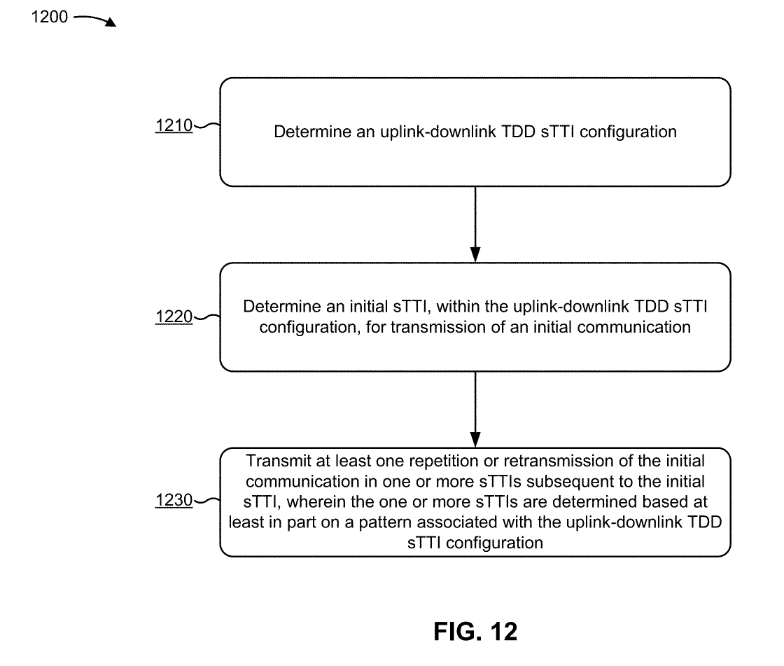

In some aspects, one or more components of UE 120 may be included in a housing. Controller/processor 240 of base station 110, controller/processor 280 of UE 120, and/or any other component(s) of FIG. 2 may perform one or more techniques associated with reliable low latency operations in TDD wireless communication systems, as described in more detail elsewhere herein. For example, controller/processor 240 of base station 110, controller/processor 280 of UE 120, and/or any other component(s) of FIG. 2 may perform or direct operations of, for example, process 1100 of FIG. 11, process 1200 of FIG. 12, and/or other processes as described herein. Memories 242 and 282 may store data and program codes for base station 110 and UE 120, respectively. A scheduler 246 may schedule UEs for data transmission on the downlink and/or uplink.

In some aspects, UE 120 and/or base station 110 may include means for determining an uplink-downlink TDD shortened transmission time interval (sTTI) configuration; means for determining an initial sTTI, within the uplink-downlink TDD sTTI configuration, for reception of an initial communication; means for monitoring one or more sTTIs, subsequent to the initial sTTI, for reception of at least one repetition or retransmission of the initial communication, wherein the one or more sTTIs are determined based at least in part on a pattern associated with the uplink-downlink TDD sTTI configuration; and/or the like. Additionally, or alternatively, UE 120 and/or base station 110 may include means for determining an uplink-downlink TDD sTTI configuration; means for determining an initial sTTI, within the uplink-downlink TDD sTTI configuration, for transmission of an initial communication; means for transmitting at least one repetition or retransmission of the initial communication in one or more sTTIs subsequent to the initial sTTI, wherein the one or more sTTIs are determined based at least in part on a pattern associated with the uplink-downlink TDD sTTI configuration; and/or the like. In some aspects, such means may include one or more components of UE 120 and/or base station 110 described in connection with FIG. 2.

As indicated above, FIG. 2 is provided as an example. Other examples may differ from what is described with regard to FIG. 2.

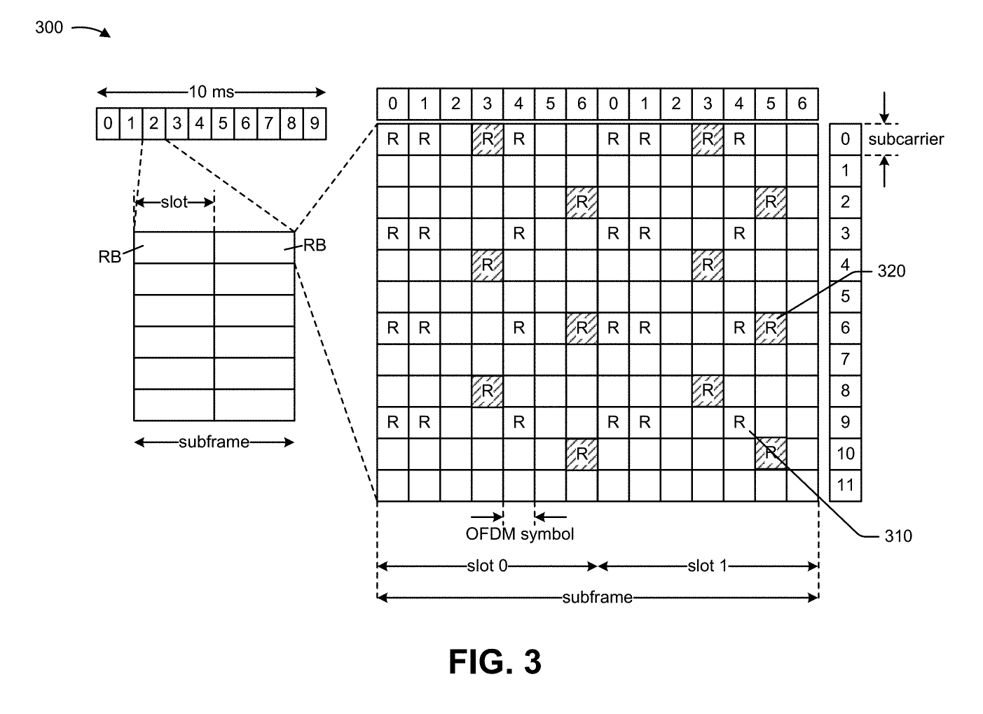

FIG. 3 is a diagram illustrating an example 300 of a frame structure in a wireless communication network, in accordance with various aspects of the present disclosure. In some aspects, the frame may be a downlink frame, and the wireless communication network may be LTE.

A frame (e.g., of 10 ms) may be divided into 10 equally sized sub-frames with indices of 0 through 9. Each sub-frame may include two consecutive time slots. A resource grid may be used to represent two time slots, each time slot including a resource block (RB). The resource grid is divided into multiple resource elements. In LTE, a resource block includes 12 consecutive subcarriers in the frequency domain and, for a normal cyclic prefix in each OFDM symbol, 7 consecutive OFDM symbols in the time domain, or 84 resource elements. For an extended cyclic prefix, a resource block includes 6 consecutive OFDM symbols in the time domain and has 72 resource elements. Some of the resource elements, as indicated as R 310 and R 320, include DL reference signals (DL-RS). The DL-RS include Cell-specific RS (CRS) (also sometimes called common RS) 310 and UE-specific RS (UE-RS) 320. UE-RS 320 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

In LTE, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix (CP). The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in the first symbol period of each subframe. The PCFICH may convey the number of symbol periods (M) used for control channels, where M may be equal to 1, 2, or 3 and may change from subframe to subframe. M may also be equal to 4 for a small system bandwidth, e.g., with less than 10 resource blocks. The eNB may send a Physical HARQ Indicator Channel (PHICH) and a Physical Downlink Control Channel (PDCCH) in the first M symbol periods of each subframe. The PHICH may carry information to support hybrid automatic repeat request (HARQ). The PDCCH may carry information on resource allocation for UEs and control information for downlink channels. The eNB may send a Physical Downlink Shared Channel (PDSCH) in the remaining symbol periods of each subframe. The PDSCH may carry data for UEs scheduled for data transmission on the downlink.

The eNB may send the PSS, SSS, and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH, and PHICH in a broadcast manner to all UEs, may send the PDCCH in a unicast manner to specific UEs, and may also send the PDSCH in a unicast manner to specific UEs.

A number of resource elements may be available in each symbol period. Each resource element (RE) may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1, and 2. The PDCCH may occupy 9, 18, 36, or 72 REGs, which may be selected from the available REGs, in the first M symbol periods, for example. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

In LTE, a transmission time interval (TTI) may be equivalent to a subframe, with a duration of 1 ms. A shortened transmission time interval (sTTI) may be a time interval that is less than the duration of a subframe (e.g., less than 1 ms). For example, an sTTI may be equivalent to a slot, with a duration of 0.5 ms. In some aspects, an sTTI may have a different duration, such as any number of symbols that is shorter than a subframe (e.g., less than 14 symbols, less than 12 symbols, and/or the like).

As indicated above, FIG. 3 is provided as an example. Other examples may differ from what is described above in connection with FIG. 3.

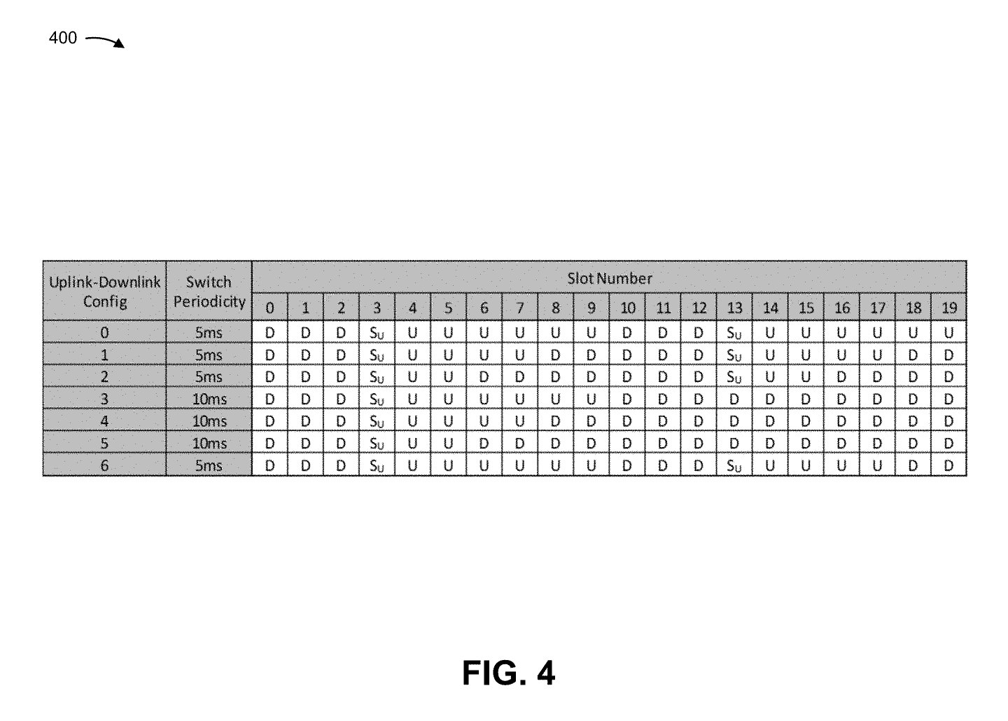

FIG. 4 is a diagram illustrating an example 400 relating to reliable low latency operations in TDD wireless communication systems, in accordance with various aspects of the present disclosure.

As shown in FIG. 4, a UE 120 and/or a base station 110 may be configured to communicate using an uplink-downlink (UL-DL) TDD sTTI configuration, shown as 7 different configurations with indices of 0 through 6. An UL-DL TDD sTTI configuration may define an arrangement of sTTIs, in a radio frame, reserved for downlink transmissions (shown as “D”), uplink transmissions (shown as “U”), and/or special uplink transmissions (shown as “Su”). Additionally, or alternatively, an UL-DL TDD sTTI may define a switch-point periodicity for switching from a downlink sTTI (e.g., “D”) to an uplink sTTI (e.g., “U”). As shown, different UL-DL TDD sTTI configurations may have different allocations of uplink and downlink sTTIs across a radio frame, and may be used for different applications and/or network load conditions depending on an expected load of uplink transmissions and/or downlink transmissions. In some aspects, an UL-DL TDD sTTI configuration used for communications between a UE 120 and a base station 110 may be dynamically and/or semi-statically signaled, and may be changed based at least in part on the signaling.

In example 400, the UL-DL TDD sTTI configurations are derived from the seven predefined UL-DL TDD subframe configurations (e.g., with 1 ms subframes), and show an example of slot-based sTTIs of 0.5 ms. However, some techniques and apparatuses described herein may apply to sTTIs with other durations (e.g., 2 symbols, 3 symbols, and/or the like). In some aspects, the uplink-downlink TDD sTTI configuration is based at least in part on an uplink-downlink TDD subframe configuration of a carrier associated with the uplink-downlink TDD sTTI configuration. For example, the carrier may use an uplink-downlink TDD subframe configuration with a TTI that is different than an sTTI used for URLLC. In some aspects, the uplink-downlink TDD subframe configuration may be signaled (e.g., in a SIB, and/or the like), and the uplink-downlink TDD sTTI configuration may be determined based at least in part on the uplink-downlink TDD subframe configuration.

In some aspects, a UE 120 and a base station 110 may communicate in a low latency mode and/or a high reliability mode (e.g., a URLLC mode) that is associated with a latency requirement and/or a reliability requirement (e.g., low latency and/or high reliability). As an example, the latency and/or reliability requirement may require, for example, that packets be delivered over the air interface with a latency of 10 ms and a reliability of 99.999%, meaning that fewer than one out of 10⁵ packets are permitted to be delivered with a latency greater than 10 ms over the air interface between the UE 120 and the base station 110. In some aspects, other latency and/or reliability requirements may be used.

To satisfy the requirement of low latency and high reliability, a transmitting device (e.g., a UE 120, a base station 110, and/or the like) may repeat an initial transmission and/or may retransmit an initial transmission to increase the likelihood of successful reception by a receiving device (e.g., a UE 120, a base station 110, and/or the like). However, such repetitions and retransmissions use network resources (e.g., of the air interface) and processing resources (e.g., of the UE 120 and/or the base station 110), and may lead to network congestion, inefficient use of network resources, higher latency for other communications, additional use of processing resources, and/or the like. Furthermore, because different UL-DL TDD sTTI configurations have different allocations of uplink sTTIs, downlink sTTIs, and special uplink sTTIs across a radio frame, a repetition and/or retransmission scheme used to achieve low latency and high reliability in one UL-DL TDD sTTI configuration may not achieve the same result in another UL-DL TDD sTTI configuration.

Some techniques and apparatuses described herein permit low latency and high reliability communications across a variety of UL-DL TDD sTTI configurations. Furthermore, some techniques and apparatuses described herein may account for initial transmissions in different sTTIs of the UL-DL TDD sTTI configuration, may account for different channel conditions, and/or the like, in order to achieve low latency and high reliability. Furthermore, some techniques and apparatuses described herein permit configurations of repetitions and/or retransmissions in different UL-DL TDD sTTI configurations in a manner that conserves network resources and/or processing resources (e.g., as compared to a pure repetition scheme, a pure retransmission scheme, and/or the like).

As indicated above, FIG. 4 is provided as an example. Other examples may differ from what is described above in connection with FIG. 4.

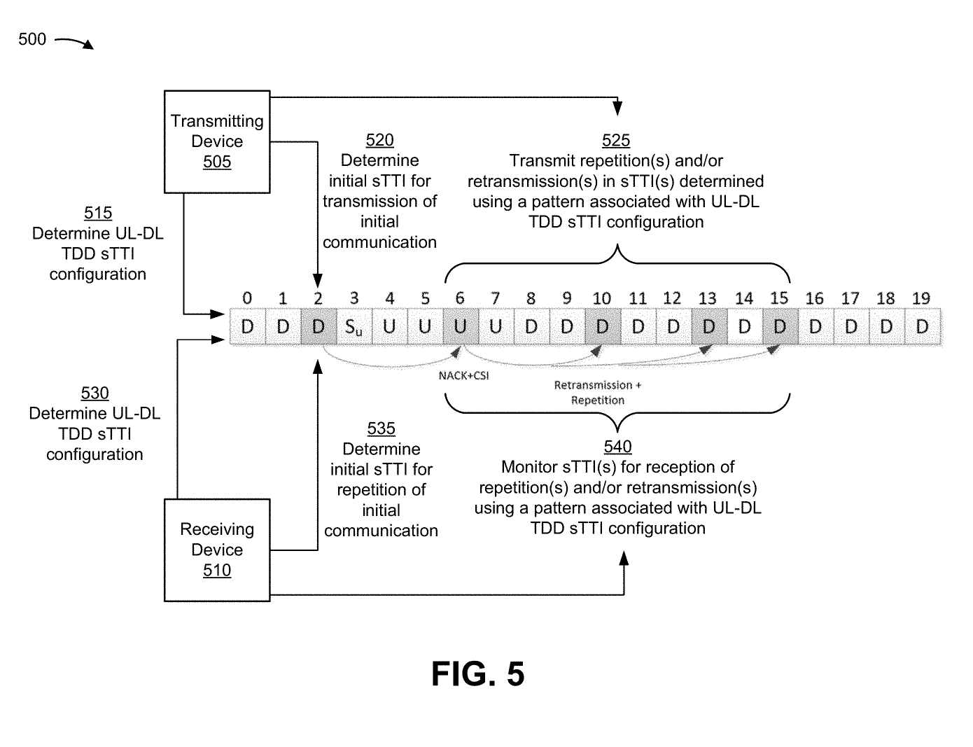

FIG. 5 is a diagram illustrating an example 500 relating to reliable low latency operations in TDD wireless communication systems, in accordance with various aspects of the present disclosure.

As shown in FIG. 5, a transmitting device 505 may communicate with a receiving device 510 over an air interface. In some aspects, the transmitting device 505 may correspond to the base station 110, the UE 120, and/or the like. Additionally, or alternatively, the receiving device 510 may correspond to the base station 110, the UE 120, and/or the like. In some aspects, the transmitting device 505 is a base station 110 and the receiving device 510 is a UE 120. In some aspects, the transmitting device 505 is a UE 120 and the receiving device 510 is a base station 110. In some aspects, the transmitting device 505 and the receiving device 510 are both base stations 110 or are both UEs 120. In some aspects, the transmitting device 505 and the receiving device 510 may communicate in a low latency mode and/or a high reliability mode, such as a URLLC mode and/or the like. Additionally, or alternatively, the transmitting device 505 and the receiving device 510 may communicate using sTTIs, and may use an UL-DL TDD sTTI configuration to configure a distribution of uplink sTTIs, downlink sTTIs, and/or special sTTIs.

As shown by reference number 515, the transmitting device 505 may determine an UL-DL TDD sTTI configuration to be used to communicate with the receiving device 510. In some aspects, the UL-DL TDD sTTI configuration may be signaled between the transmitting device 505 and the receiving device 510. For example, a base station 110 may indicate the UL-DL TDD sTTI configuration to a UE 120. For example, the UL-DL TDD sTTI configuration may be indicated in a system information block (SIB), in a radio resource control (RRC) configuration message, in downlink control information (DCI), and/or the like.

As shown by reference number 520, the transmitting device 505 may determine an initial sTTI, within the UL-DL TDD sTTI configuration, for transmission of an initial communication. An initial communication may refer to a first instance of transmission of a particular communication (e.g., data, control information, and/or the like), which may be followed by one or more repetitions and/or one or more retransmissions of the initial communication. An initial sTTI may refer to an sTTI in which the initial communication is transmitted. In example 500, the initial sTTI is sTTI 2 (e.g., the third sTTI in the UL-DL TDD sTTI configuration). In some aspects, the initial sTTI may be indicated in DCI, such as a downlink grant, an uplink grant, and/or the like. For example, a base station 110 may indicate the initial sTTI to a UE 120 in a downlink grant (e.g., when the initial communication is a downlink communication transmitted in a downlink sTTI), in an uplink grant (e.g., when the initial communication is an uplink communication transmitted in an uplink sTTI or a special uplink sTTI), and/or the like. The transmitting device 505 may transmit the initial communication in the initial sTTI.

As shown by reference number 525, the transmitting device 505 may transmit at least one repetition or retransmission of the initial communication in one or more sTTIs subsequent to the initial sTTI. In example 500, the transmitting device 505 transmits a retransmission in sTTI 10 after receiving a negative acknowledgement (NACK), corresponding to the initial communication, in sTTI 6. Furthermore, the transmitting device 505 transmits two repetitions of the initial communication, with one in sTTI 13 and one in sTTI 15. In some aspects, the one or more sTTIs for the at least one repetition or retransmission are determined based at least in part on a pattern associated with the UL-DL TDD sTTI configuration, as described in more detail elsewhere herein. In some aspects, a retransmission may refer to an additional transmission of an initial communication due to reception of a NACK. In some aspects, a repetition may refer to an additional transmission of an initial communication that is not due to reception of a NACK.

As shown by reference number 530, the receiving device 510 may determine an UL-DL TDD sTTI configuration to be used to communicate with the transmitting device 505. In some aspects, the UL-DL TDD sTTI configuration may be signaled between the transmitting device 505 and the receiving device 510, as described above in connection with reference number 515.

As shown by reference number 535, the receiving device 510 may determine an initial sTTI, within the UL-DL TDD sTTI configuration, for reception of an initial communication. In some aspects, the initial sTTI may be signaled between the transmitting device 505 and the receiving device 510, as described above in connection with reference number 520. The receiving device 510 may receive the initial communication in the initial sTTI. In some aspects, the reception may be successful, and the receiving device 510 may transmit an acknowledgement (ACK) corresponding to the initial communication, in which case, the transmitting device 505 may not transmit any retransmission or any additional repetitions after the transmitting device 505 receives the ACK. In some aspects, the reception may be unsuccessful, and the receiving device 510 may transmit a NACK corresponding to the initial communication, in which case, the transmitting device 505 may transmit a retransmission and/or additional repetitions of the initial communication.

As shown by reference number 540, the receiving device 510 may monitor one or more sTTIs, subsequent to the initial sTTI, for reception of at least one repetition or retransmission of the initial communication. In example 500, the receiving device 510 monitors sTTI 10 for a retransmission of the initial communication after transmitting a NACK, corresponding to the initial communication, in sTTI 6. Furthermore, the receiving device 510 monitors sTTI 13 and sTTI 15 for repetitions of the initial communication (e.g., if the retransmission is not successfully received by the receiving device 510). In some aspects, the one or more sTTIs for the at least one repetition or retransmission are determined based at least in part on a pattern associated with the UL-DL TDD sTTI configuration.

In some aspects, the transmitting device 505 may determine the one or more sTTIs based at least in part on a pattern that indicates one or more sTTIs in which a retransmission is to be transmitted, a pattern that indicates one or more sTTIs in which a repetition is to be transmitted, and/or the like. Additionally, or alternatively, the receiving device 510 may determine the one or more sTTIs based at least in part on a pattern that indicates one or more sTTIs in which a retransmission is to be received, a pattern that indicates one or more sTTIs in which a repetition is to be received, and/or the like. The transmitting device 505 and the receiving device 510 may determine the same pattern so as to synchronize communications between the transmitting device 505 and the receiving device 510.

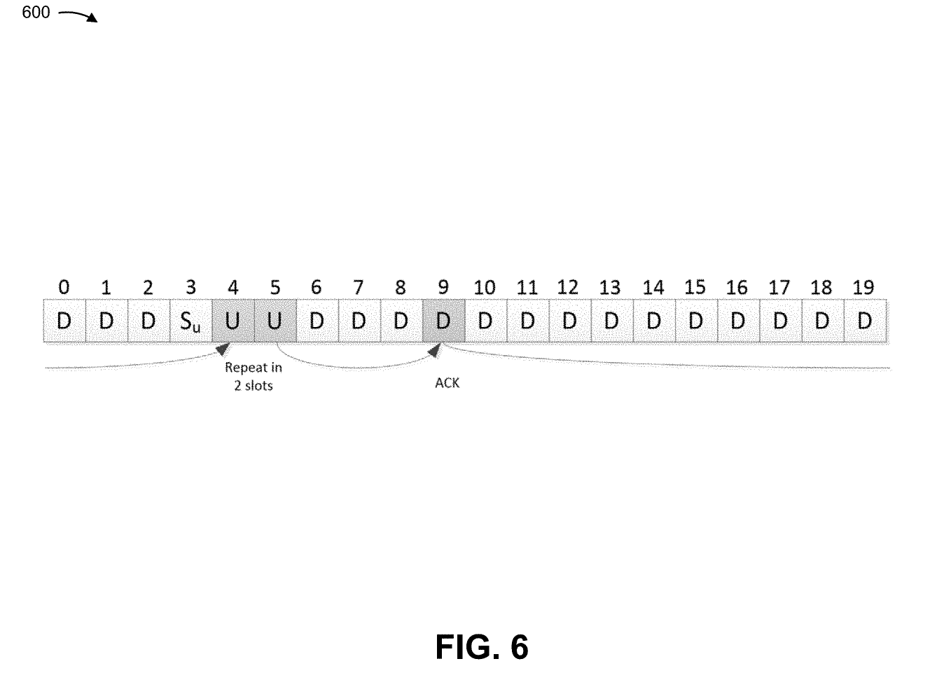

In some aspects, the pattern may be determined based at least in part on the UL-DL TDD sTTI configuration being used by the transmitting device 505 and the receiving device 510. For example, different UL-DL TDD sTTI configurations may permit different combinations of retransmissions and/or repetitions due to different allocations and/or numbers of downlink sTTIs, uplink sTTIs, and/or special uplink sTTIs across the radio frame. Example patterns associated with different UL-DL TDD sTTI configurations are described in more detail below in connection with FIGS. 6-10.

Additionally, or alternatively, the pattern may be determined based at least in part on the initial sTTI, within the UL-DL TDD sTTI configuration, in which the initial communication is transmitted and/or received. For example, different UL-DL TDD sTTI configurations may permit different combinations of retransmission and/or repetitions depending on the initial sTTI due to different sequences of downlink sTTIs, uplink sTTIs, and/or special uplink sTTIs that follow the initial sTTI. Example patterns associated with different initial sTTIs are described in more detail below in connection with FIGS. 6-10.

Additionally, or alternatively, the pattern may be determined based at least in part on channel quality information associated with a channel via which the transmitting device 505 and the receiving device 510 are communicating. For example, a larger number of repetitions may be transmitted and/or monitored when the channel quality is low, and a smaller number of repetitions may be transmitted and/or monitored when the channel quality is high. In some aspects, channel quality information may be indicated between the transmitting device 505 and the receiving device 510 using a reference signal, such as a channel state information (CSI) reference signal (CSI-RS), a sounding reference signal (SRS), and/or the like. Different UL-DL TDD sTTI configurations may permit different numbers of repetitions due to different allocations and/or numbers of downlink sTTIs, uplink sTTIs, and/or special uplink sTTIs across the radio frame, as well as different sequences of downlink sTTIs, uplink sTTIs, and/or special uplink sTTIs that follow the initial sTTI.

In some aspects, the pattern may be hard coded in memory of the transmitting device 505 and/or the receiving device 510. For example, the transmitting device 505 and/or the receiving device 510 may store a table or other data structure that indicates a pattern to be used for an UL-DL TDD sTTI configuration, an initial sTTI within the UL-DL TDD sTTI configuration, channel quality information, and/or the like. In this case, the transmitting device 505 and/or the receiving device 510 may look up the pattern using one or more of the UL-DL TDD sTTI configuration, the initial sTTI within the UL-DL TDD sTTI configuration, the channel quality information, and/or the like. In some aspects, the transmitting device 505 and the receiving device 510 may store the same table so that communications can be synchronized.

Additionally, or alternatively, the pattern may be indicated between the transmitting device 505 and the receiving device 510. In some aspects, the pattern may be indicated in an RRC configuration message, in DCI, and/or the like. For example, a base station 110 may indicate the pattern to a UE 120, such as using an RRC configuration message, DCI, and/or the like. In this way, the pattern may be semi-statically or dynamically indicated. In some aspects, a first pattern may be hard coded in memory of the transmitting device 505 and/or the receiving device 510, and may be overridden using a second pattern indicated between the transmitting device 505 and the receiving device 510. Additionally, or alternatively, the pattern may be determined based at least in part on a determination of one or more anchor sTTIs (e.g., an sTTI that is not dynamically reconfigurable as an uplink sTTI or a downlink sTTI) and/or one or more non-anchor sTTIs (e.g., an sTTI that is dynamically reconfigurable as an uplink sTTI or a downlink sTTI, such as by using DCI) associated with enhanced Interference Mitigation and Traffic Adaptation (eIMTA).

In some aspects, the pattern may be designed to permit satisfaction of a latency requirement and/or a reliability requirement. For example, the pattern may be designed to permit satisfaction of a URLLC requirement. As a specific example, the latency requirement and/or the reliability requirement may require, for example, that communications (e.g., packets of a particular size, such as 32 bytes and/or the like) be delivered between the transmitting device 505 and the receiving device 510 (e.g., over an air interface) with a latency of 10 ms or less and a reliability of 99.999% or higher, meaning that fewer than one out of 10⁵ communications are permitted to be delivered with a latency greater than 10 ms. In some aspects, the pattern may be designed to permit satisfaction of a latency requirement relating to a particular number of sTTIs (e.g., 20 sTTIs, corresponding to 10 ms, and/or the like).

In some aspects, the UL-DL TDD sTTI configuration may include a threshold number of repetition opportunities to permit satisfaction of the latency requirement and/or the reliability requirement. Additionally, or alternatively, the UL-DL TDD sTTI configuration may include an sTTI allocation (e.g., an allocation of downlink sTTIs, uplink sTTIs, and/or special uplink sTTIs) that permits a retransmission timing (e.g., a number of sTTIs) that satisfies the latency requirement and/or the reliability requirement. The retransmission timing may include, for example, an acknowledgement or negative acknowledgement (ACK/NACK) feedback timing between reception or transmission of a communication and transmission or reception of an ACK or a NACK corresponding to the communication, a timing between transmission or reception of the initial communication and a first available sTTI for retransmission, a timing between transmission or reception of ACK/NACK feedback and the first available sTTI for retransmission, and/or the like.

To permit satisfaction of the latency requirement and/or the reliability requirement, some UL-DL TDD sTTI configurations (e.g., one or more UL-DL sTTI configurations shown in FIG. 4) may be excluded from when the transmitting device 505 and the receiving device 510 are operating in the low latency mode and/or the high reliability mode (e.g., the URLLC mode). For example, UL-DL TDD sTTI configurations that do not include the threshold number of repetition opportunities and/or that do not permit a retransmission timing that satisfies a threshold may be excluded from use in URLLC.

By using different patterns based at least in part on a combination of an UL-DL TDD sTTI configuration, an initial sTTI, and/or channel quality information, a transmitting device 505 and a receiving device 510 may ensure that a low latency requirement and/or a high reliability requirement is satisfied in a variety of communication scenarios. In this way, latency may be reduced, reliability may be improved, and resources (e.g., network resources, processing resources, and/or the like) may be efficiently used.

As indicated above, FIG. 5 is provided as an example. Other examples may differ from what is described above in connection with FIG. 5.

FIG. 6 is a diagram illustrating an example 600 relating to reliable low latency operations in TDD wireless communication systems, in accordance with various aspects of the present disclosure.

FIG. 6 shows an example pattern of repetitions and/or retransmissions that may be used for the example UL-DL TDD sTTI configuration (sometimes referred to as an sTTI configuration below) having an index of 5, as shown in FIG. 4. In FIG. 6, the initial communication and the repetitions and/or retransmissions are uplink communications. In this sTTI configuration, due to the heavy allocation of downlink sTTIs, an uplink communication cannot be retransmitted with a retransmission timing that satisfies the latency requirement and/or the reliability requirement.

For example, an initial uplink communication transmitted in sTTI 4 may be acknowledged (ACKed) or negatively acknowledged (NACKed) in sTTI 8 when the ACK/NACK feedback timing is 4 sTTIs and/or 4 ms (e.g., 4 TTIs in LTE). However, the next available retransmission opportunity for the uplink communication, after receipt of the ACK/NACK feedback, would not be until either sTTI 3 or sTTI 4 of the next frame (e.g., if a size of the uplink communication is less than a threshold, then a special uplink sTTI, such as sTTI 3, may be used for the uplink communication). In this case, a retransmission cannot be performed with a latency that satisfies a threshold time (e.g., 10 ms) and/or a threshold number of sTTIs (e.g., 20 sTTIs).

In this case, when the uplink-downlink TDD sTTI configuration does not permit a retransmission timing that satisfies at least one of a latency requirement or a reliability requirement (e.g., a 10 ms latency requirement and/or the like), then the pattern may include one or more repetitions and no retransmissions, as shown. For example, when an initial communication occurs in sTTI 4 in this sTTI configuration (e.g., with an index of 5), the pattern may indicate a repetition in sTTI 5. In this case, the transmitting device 505 may transmit the repetition in sTTI 5, and the receiving device 510 may monitor for the repetition in sTTI 5, based at least in part on the pattern (e.g., associated with the sTTI configuration and the initial sTTI). In this way, a likelihood of satisfying the latency requirement and/or the reliability requirement (e.g., a URLLC requirement) may be increased.

In some aspects, the UL-DL TDD sTTI configuration with an index of 5, as shown in FIG. 4, may be excluded from use by the transmitting device 505 and the receiving device 510 when the transmitting device 505 and the receiving device 510 are operating in a low latency mode and/or a high reliability mode (e.g., a URLLC mode). For example, this sTTI configuration may be excluded from use because this sTTI configuration does not include a threshold number of repetition opportunities (e.g., includes less than 3 uplink repetition opportunities, includes less than 2 uplink repetition opportunities, and/or the like). Additionally, or alternatively, this sTTI configuration may be excluded from use because this sTTI configuration does not include an sTTI allocation that permits a retransmission timing that satisfies a threshold (e.g., 10 ms). In this way, a likelihood of satisfying a latency requirement and/or a reliability requirement may be increased by excluding sTTI configurations that do not permit satisfaction of the latency requirement and/or the reliability requirement, or that have a low likelihood of satisfying the latency requirement and/or the reliability requirement.

As indicated above, FIG. 6 is provided as an example. Other examples may differ from what is described above in connection with FIG. 6.

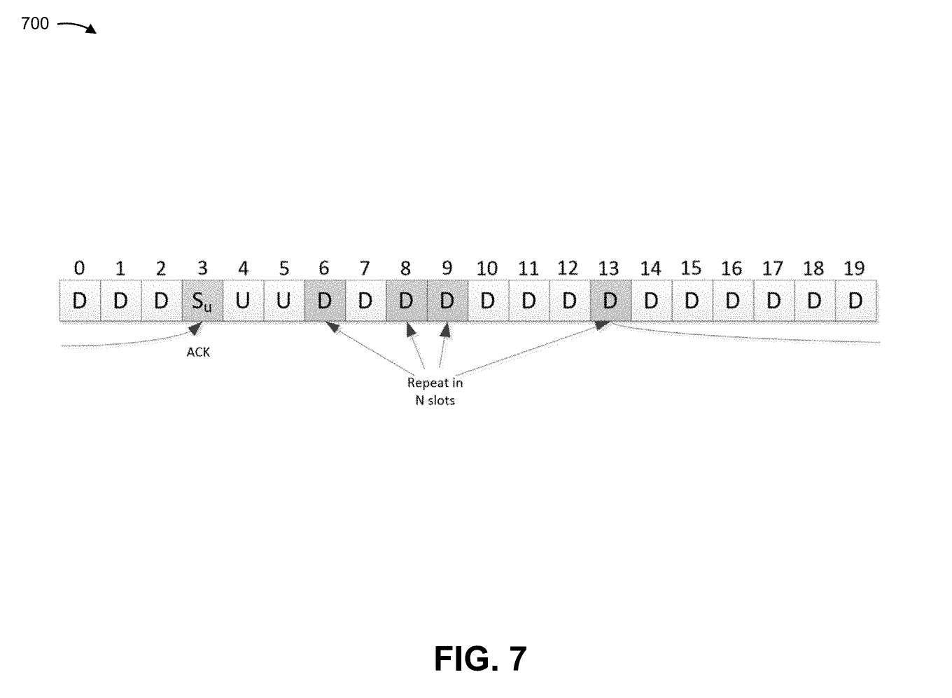

FIG. 7 is a diagram illustrating an example 700 relating to reliable low latency operations in TDD wireless communication systems, in accordance with various aspects of the present disclosure.

FIG. 7 shows another example pattern of repetitions and/or retransmissions that may be used for the example UL-DL TDD sTTI configuration having an index of 5, as shown in FIG. 4. In FIG. 7, the initial communication and the repetitions and/or retransmissions are downlink communications. In this sTTI configuration, due to the allocation of only downlink sTTIs after sTTI 5, a retransmission of an initial communication transmitted after sTTI 5 cannot be transmitted with a retransmission timing that satisfies the latency requirement and/or the reliability requirement.

For example, ACK/NACK feedback corresponding to an initial downlink communication transmitted after sTTI 5 cannot be transmitted until at least sTTI 3 in the following frame (e.g., the next uplink opportunity after the initial downlink communication), and a corresponding retransmission could not occur until sTTI 6 in the following frame (e.g., the next downlink opportunity after the ACK/NACK feedback). In this case, the transmitting device 505 may not be able to perform a retransmission with a latency that satisfies a threshold time (e.g., 10 ms) and/or a threshold number of sTTIs (e.g., 20 sTTIs).

As indicated above in connection with FIG. 6, when the sTTI configuration does not permit a retransmission timing that satisfies at least one of a latency requirement or a reliability requirement (e.g., a 10 ms latency requirement and/or the like), then the pattern may include one or more repetitions and no retransmissions, as shown. For example, when an initial communication occurs in sTTI 6 in this sTTI configuration (e.g., with an index of 5), the pattern may indicate repetitions in sTTIs 8, 9, and 13. In this case, the transmitting device 505 may transmit the repetitions in sTTIs 8, 9, and 13, and the receiving device 510 may monitor for the repetitions in sTTIs 8, 9, and 13 based at least in part on the pattern (e.g., associated with the sTTI configuration and the initial sTTI). In this way, a likelihood of satisfying the latency requirement and/or the reliability requirement (e.g., a URLLC requirement) may be increased.

Although not shown, in some aspects, a final repetition, of the one or more repetitions indicated in the pattern, satisfies a specified timing for transmission of ACK/NACK feedback corresponding to the final repetition. For example, in LTE, the specified timing may be 4 sTTIs. In this case, a final repetition may be transmitted in sTTI 19, such that ACK/NACK feedback corresponding to the final repetition occurs in sTTI 3 (e.g., 4 sTTIs later). In this way, an ACK/NACK timing requirement may be satisfied. Furthermore, network resources may be conserved by transmitting ACK/NACK feedback only for the final repetition (e.g., and not for other repetitions).

In some aspects, the pattern is determined based at least in part on a number of repetitions (e.g., N) associated with the initial communication. In some aspects, the number of repetitions may be determined based at least in part on channel quality information, such as channel quality information indicated by CSI-RS, SRS, and/or the like. In some aspects, the number of repetitions may be indicated in an RRC configuration message, in DCI, and/or the like. For example, a grant for an initial communication may indicate the number of repetitions. Additionally, or alternatively, the number of repetitions may be determined based at least in part on a load associated with the transmitting device 505 and/or the receiving device 510 (e.g., the load associated with a base station 110). In this way, the pattern may be adapted for different sTTI configurations, different initial sTTIs, different channel conditions, different base station loads, and/or the like.

As indicated above, FIG. 7 is provided as an example. Other examples may differ from what is described above in connection with FIG. 7.

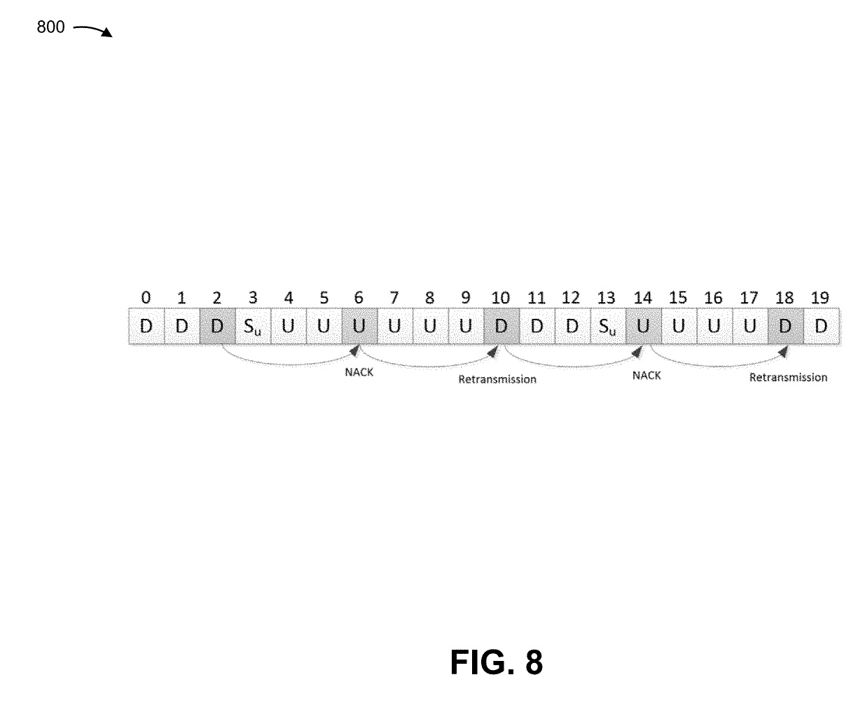

FIG. 8 is a diagram illustrating an example 800 relating to reliable low latency operations in TDD wireless communication systems, in accordance with various aspects of the present disclosure.

FIG. 8 shows an example pattern of repetitions and/or retransmissions that may be used for an example UL-DL TDD sTTI configuration having an index of 6, as shown in FIG. 4. In FIG. 8, the initial communication and the repetitions and/or retransmissions are downlink communications. In this sTTI configuration, due to the allocation and spacing of uplink sTTIs and downlink sTTIs, a latency requirement and/or a reliability requirement may be satisfied using only retransmissions of an initial communication (e.g., without using repetitions).

For example, and as shown, an initial communication transmitted in sTTI 2 may be ACKed or NACKed in sTTI 6, and a retransmission may be transmitted in sTTI 10 if the initial communication is NACKed. The retransmission in sTTI 10 may be ACKed or NACKed in sTTI 14, and another retransmission may be transmitted in sTTI 18 if the retransmission in sTTI 10 is NACKed. In this case, the number of ACK/NACK and/or retransmission opportunities may be sufficient to satisfy the latency requirement and/or the reliability requirement.

In some aspects, when the sTTI configuration includes a threshold number of opportunities for transmission of ACK/NACK feedback and/or corresponding retransmissions (e.g., 2 opportunities, 3 opportunities, and/or the like), then the pattern may include one or more retransmissions and no repetitions, as shown. For example, when an initial communication occurs in sTTI 2 in this sTTI configuration (e.g., with an index of 6), the pattern may indicate retransmissions in sTTIs 10 and 18 (e.g., which are transmitted in the case of a NACK of a prior transmission). In this case, the transmitting device 505 may transmit the retransmission and the receiving device 510 may monitor for the retransmission in sTTI 10 if the initial communication in sTTI 2 is NACKed. Similarly, the transmitting device 505 may transmit the retransmission and the receiving device 510 may monitor for the retransmission in sTTI 18 if the retransmission in sTTI 10 is NACKed. In this way, a likelihood of satisfying the latency requirement and/or the reliability requirement (e.g., a URLLC requirement) may be increased, while also conserving resources (e.g., by not transmitting unnecessary repetitions).

In some aspects, the pattern may include one or more retransmissions and no repetitions, as shown in FIG. 8, if channel quality, as indicated by channel quality information, satisfies a threshold. Conversely, if the channel quality does not satisfy the threshold, then one or more repetitions may be included in the pattern in addition to the one or more retransmissions. In this way, the likelihood of satisfying the latency requirement and/or the reliability requirement may be increased for dynamic channel conditions, while still conserving network resources.

As indicated above, FIG. 8 is provided as an example. Other examples may differ from what is described above in connection with FIG. 8.

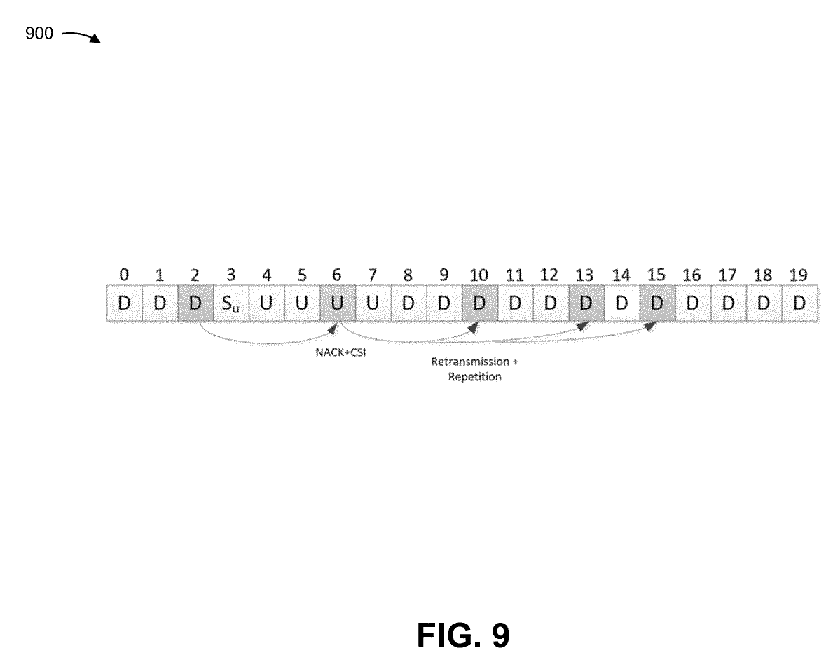

FIG. 9 is a diagram illustrating an example 900 relating to reliable low latency operations in TDD wireless communication systems, in accordance with various aspects of the present disclosure.

FIG. 9 shows an example pattern of repetitions and/or retransmissions that may be used for an example UL-DL TDD sTTI configuration having an index of 4, as shown in FIG. 4. In FIG. 9, the initial communication and the repetitions and/or retransmissions are downlink communications. In this sTTI configuration, due to the allocation and spacing of uplink sTTIs and downlink sTTIs, a latency requirement and/or a reliability requirement may be satisfied using both one or more retransmissions and one or more repetitions of an initial communication.

For example, and as shown, an initial communication transmitted in sTTI 2 may be ACKed or NACKed in sTTI 6, and a retransmission may be transmitted in sTTI 10 if the initial communication is NACKed. The retransmission in sTTI 10 may also be repeated as repetitions in sTTIs 13 and 15. In this case, the number of ACK/NACK and/or retransmission opportunities may satisfy a first threshold (e.g., 1), but may not satisfy a second threshold (e.g., 2).

In some aspects, when the sTTI configuration includes a number of opportunities for transmission of ACK/NACK feedback and/or corresponding retransmissions that satisfies a first threshold but that does not satisfy a second threshold, then the pattern may include one or more retransmissions and one or more repetitions. As shown, in some aspects, the pattern may include a retransmission (or multiple retransmissions) followed by one or more repetitions. For example, when an initial communication occurs in sTTI 2 in this sTTI configuration (e.g., with an index of 4), the pattern may indicate a retransmission in sTTI 10 and repetitions in sTTI 13 and sTTI 15. In this case, the transmitting device 505 may transmit, and the receiving device 510 may monitor for, the retransmission in sTTI 10 and the repetitions in sTTI 13 and sTTI 15 if the initial communication in sTTI 2 is NACKed. In this way, a likelihood of satisfying the latency requirement and/or the reliability requirement (e.g., a URLLC requirement) may be increased.

In some aspects, when the pattern includes a retransmission followed by one or more repetitions, the number of the one or more repetitions may be determined based at least in part on channel quality information reported by the receiving device 510 in connection with transmission of a NACK corresponding to the initial communication. For example, when transmitting the NACK in sTTI 6, the receiving device 510 may also report channel quality information, shown as CSI. The transmitting device 505 and the receiving device 510 may use the channel quality information to determine a number of repetitions and a corresponding pattern for the number of repetitions. In this way, the pattern may be adapted to dynamic channel conditions to increase the likelihood of satisfying a latency requirement and/or a reliability requirement while conserving network resources.

As indicated above, FIG. 9 is provided as an example. Other examples may differ from what is described above in connection with FIG. 9.

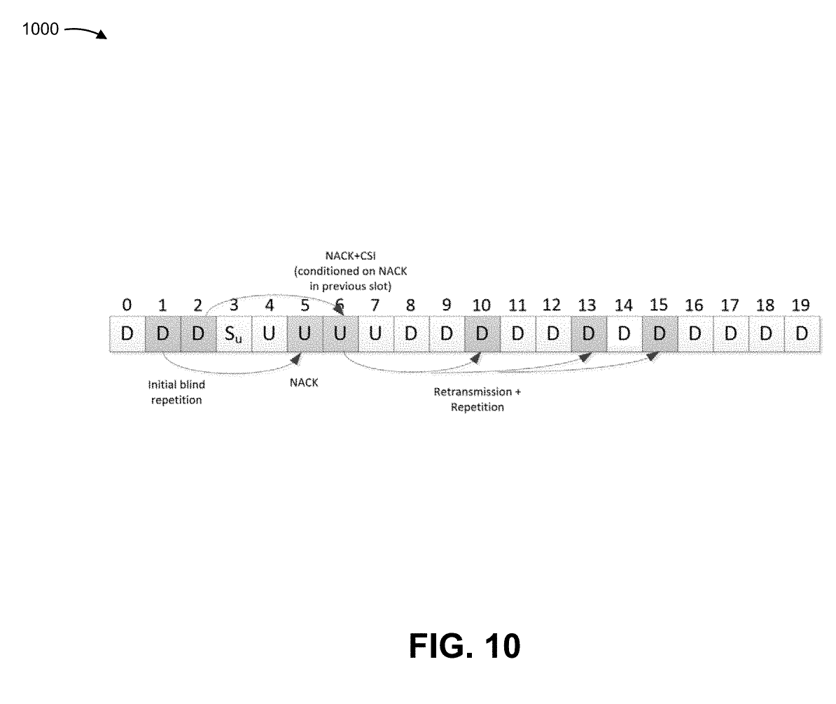

FIG. 10 is a diagram illustrating an example 1000 relating to reliable low latency operations in TDD wireless communication systems, in accordance with various aspects of the present disclosure.

FIG. 10 shows another example pattern of repetitions and/or retransmissions that may be used for the example UL-DL TDD sTTI configuration having an index of 4, as shown in FIG. 4. In FIG. 10, the initial communication and the repetitions and/or retransmissions are downlink communications. In this sTTI configuration, due to the allocation and spacing of uplink sTTIs and downlink sTTIs, a latency requirement and/or a reliability requirement may be satisfied using both one or more retransmissions and one or more repetitions of an initial communication.

For example, and as shown, an initial communication transmitted in sTTI 1 may be repeated as a repetition in sTTI 2. In some aspects, ACK/NACK feedback for the initial communication in sTTI 1 may be transmitted in sTTI 5, and ACK/NACK feedback for the repetition in sTTI 2 may be transmitted in sTTI 6. As further shown, a retransmission may be transmitted in sTTI 10 if both the initial communication in sTTI 1 and the repetition in sTTI 2 are NACKed. In some aspects, the retransmission in sTTI 10 may be repeated as repetitions in sTTIs 13 and 15, in a similar manner as described above in connection with FIG. 9. In this case, the number of ACK/NACK and/or retransmission opportunities may satisfy a first threshold (e.g., 1), but may not satisfy a second threshold (e.g., 2).

In some aspects, when the sTTI configuration includes a number of opportunities for transmission of ACK/NACK feedback and/or corresponding retransmissions that satisfies a first threshold but that does not satisfy a second threshold, then the pattern may include one or more retransmissions and one or more repetitions, as indicated above in connection with FIG. 9. As shown, in some aspects, the pattern may include one or more repetitions followed by one or more retransmissions (e.g., which may be followed by one or more additional repetitions, in some aspects). For example, when an initial communication occurs in sTTI 1 in this sTTI configuration (e.g., with an index of 4), the pattern may indicate a repetition in sTTI 2, a retransmission in sTTI 10, and repetitions in sTTI 13 and sTTI 15. In this case, the transmitting device 505 may transmit, and the receiving device 510 may monitor for, the repetition in sTTI 2. If the initial communication in sTTI 1 and the repetition in sTTI 2 are both NACKed, then the transmitting device 505 may transmit, and the receiving device 510 may monitor for, the retransmission in sTTI 10 and the repetitions in sTTI 13 and sTTI 15. In this way, a likelihood of satisfying the latency requirement and/or the reliability requirement (e.g., a URLLC requirement) may be increased.

In some aspects, when the pattern includes one or more repetitions followed by one or more retransmissions, the receiving device 510 may report channel quality information in connection with transmission of a NACK corresponding to a final repetition of the one or more repetitions. For example, and as shown, the receiving device 510 may transmit a NACK in sTTI 5, corresponding to the initial communication in sTTI 1, that does not include channel quality information (e.g., CSI) because the initial communication is followed by a repetition prior to an ACK/NACK opportunity. However, the receiving device 510 may transmit a NACK in sTTI 6, corresponding to the repetition in sTTI 2 (e.g., a final repetition prior to an ACK/NACK opportunity), that includes channel quality information, such as CSI. In some aspects, the receiving device 510 may transmit the channel quality information in connection with the NACK corresponding to the final repetition based at least in part on a determination that the initial communication and all prior repetitions have also been NACKed. In this way, network resources and processing resources may be conserved by transmitting channel quality information only in certain conditions.

In some aspects, a number of one or more additional repetitions, subsequent to a retransmission, may be determined based at least in part on the channel quality information reported by the receiving device 510 (e.g., in connection with transmission of a NACK corresponding to the final repetition of the one or more repetitions transmitted and/or received prior to the retransmission). For example, when transmitting the NACK in sTTI 6, the receiving device 510 may also report channel quality information, shown as CSI. The transmitting device 505 and the receiving device 510 may use the channel quality information to determine a number of repetitions and a corresponding pattern for the number of repetitions. In this way, the pattern may be adapted to dynamic channel conditions to increase the likelihood of satisfying a latency requirement and/or a reliability requirement while conserving network resources.

As indicated above, FIG. 10 is provided as an example. Other examples may differ from what is described above in connection with FIG. 10.

FIG. 11 is a diagram illustrating an example process 1100 performed, for example, by a receiving device, in accordance with various aspects of the present disclosure. Example process 1100 is an example where a receiving device (e.g., receiving device 510, UE 120, base station 110, and/or the like) performs reliable low latency operations in a TDD wireless communication system.

As shown in FIG. 11, in some aspects, process 1100 may include determining an uplink-downlink TDD sTTI configuration (block 1110). For example, the receiving device may determine (e.g., using controller/processor 240, controller/processor 280 and/or the like) an uplink-downlink TDD sTTI configuration, as described above in connection with FIGS. 4-10.

As further shown in FIG. 11, in some aspects, process 1100 may include determining an initial sTTI, within the uplink-downlink TDD sTTI configuration, for reception of an initial communication (block 1120). For example, the receiving device may determine (e.g., using controller/processor 240, controller/processor 280 and/or the like) an initial sTTI, within the uplink-downlink TDD sTTI configuration, for reception of an initial communication, as described above in connection with FIGS. 4-10.

As further shown in FIG. 11, in some aspects, process 1100 may include monitoring one or more sTTIs, subsequent to the initial sTTI, for reception of at least one repetition or retransmission of the initial communication, wherein the one or more sTTIs are determined based at least in part on a pattern associated with the uplink-downlink TDD sTTI configuration (block 1130). For example, the receiving device may monitor (e.g., using antenna 234, DEMOD 232, MIMO detector 236, receive processor 238, controller/processor 240, antenna 252, DEMOD 254, MIMO detector 256, receive processor 258, controller/processor 280, and/or the like) one or more sTTIs, subsequent to the initial sTTI, for reception of at least one repetition or retransmission of the initial communication, as described above in connection with FIGS. 4-10. In some aspects, the one or more sTTIs are determined based at least in part on a pattern associated with the uplink-downlink TDD sTTI configuration, as described above in connection with FIGS. 4-10.

Process 1100 may include additional aspects, such as any single aspect or any combination of aspects described below.

In some aspects, the pattern is determined based at least in part on the initial sTTI. In some aspects, the pattern is determined based at least in part on channel quality information. In some aspects, the pattern is indicated in at least one of: a radio resource control (RRC) configuration message, downlink control information (DCI), or some combination thereof. In some aspects, the pattern is determined based at least in part on a number of repetitions associated with the initial communication. In some aspects, the number of repetitions is indicated in downlink control information.

In some aspects, the pattern permits satisfaction of at least one of a latency requirement or a reliability requirement. In some aspects, the uplink-downlink TDD sTTI configuration includes: a threshold number of repetition opportunities, an sTTI allocation that permits a retransmission timing that satisfies a threshold, or some combination thereof. In some aspects, a final repetition, of the at least one repetition or retransmission of the initial communication, satisfies a specified timing for transmission of acknowledgement or negative acknowledgement (ACK/NACK) feedback corresponding to the final repetition.

In some aspects, the pattern includes one or more repetitions and no retransmissions. In some aspects, the pattern includes the one or more repetitions and no retransmissions when the uplink-downlink TDD sTTI configuration does not permit a retransmission timing that satisfies at least one of a latency requirement or a reliability requirement.

In some aspects, the pattern includes one or more retransmissions and no repetitions. In some aspects, the pattern includes the one or more retransmissions and no repetitions when the uplink-downlink TDD sTTI configuration includes a threshold number of opportunities for transmission of acknowledgement or negative acknowledgement (ACK/NACK) feedback and corresponding retransmissions.

In some aspects, the pattern includes one or more repetitions and one or more retransmissions. In some aspects, the pattern includes the one or more repetitions and the one or more retransmissions when a number of opportunities for transmission of acknowledgement or negative acknowledgement (ACK/NACK) feedback and corresponding retransmissions satisfies a first threshold but does not satisfy a second threshold.

In some aspects, the pattern includes a retransmission followed by one or more repetitions. In some aspects, a number of the one or more repetitions is determined based at least in part on channel quality information reported by the receiving device in connection with transmission of a negative acknowledgement (NACK) corresponding to the initial communication.

In some aspects, the pattern includes one or more repetitions followed by one or more retransmissions. In some aspects, channel quality information is reported by the receiving device in connection with transmission of a negative acknowledgement (NACK) corresponding to a final repetition of the one or more repetitions. In some aspects, the one or more retransmissions are followed by one or more additional repetitions, wherein a number of the one or more additional repetitions is determined based at least in part on the channel quality information reported by the receiving device.

In some aspects, the pattern is determined based at least in part on a determination of one or more anchor sTTIs or one or more non-anchor sTTIs associated with enhanced interference mitigation and traffic adaptation. In some aspects, the pattern permits satisfaction of a latency requirement relating to a particular number of sTTIs. In some aspects, the receiving device is operating in an ultra-reliable low latency communication (URLLC) mode, and the pattern permits satisfaction of a URLLC requirement. In some aspects, the receiving device is a user equipment. In some aspects, the receiving device is a base station. In some aspects, the uplink-downlink TDD sTTI configuration is based at least in part on an uplink-downlink TDD subframe configuration of a carrier associated with the uplink-downlink TDD sTTI configuration.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a transmitting device, in accordance with various aspects of the present disclosure. Example process 1200 is an example where a transmitting device (e.g., transmitting device 505, UE 120, base station 110, and/or the like) performs reliable low latency operations in a TDD wireless communication system.

As shown in FIG. 12, in some aspects, process 1200 may include determining an uplink-downlink TDD sTTI configuration (block 1210). For example, the transmitting device may determine (e.g., using controller/processor 240, controller/processor 280 and/or the like) an uplink-downlink TDD sTTI configuration, as described above in connection with FIGS. 4-10.

As further shown in FIG. 12, in some aspects, process 1200 may include determining an initial sTTI, within the uplink-downlink TDD sTTI configuration, for transmission of an initial communication (block 1220). For example, the transmitting device may determine (e.g., using controller/processor 240, controller/processor 280 and/or the like) an initial sTTI, within the uplink-downlink TDD sTTI configuration, for transmission of an initial communication, as described above in connection with FIGS. 4-10.

As further shown in FIG. 12, in some aspects, process 1200 may include transmitting at least one repetition or retransmission of the initial communication in one or more sTTIs subsequent to the initial sTTI, wherein the one or more sTTIs are determined based at least in part on a pattern associated with the uplink-downlink TDD sTTI configuration (block 1230). For example, the transmitting device may transmit (e.g., using controller/processor 240, transmit processor 220, TX MIMO processor 230, MOD 232, antenna 234, controller/processor 280, transmit processor 264, TX MIMO processor 266, MOD 254, antenna 252, and/or the like) at least one repetition or retransmission of the initial communication in one or more sTTIs subsequent to the initial sTTI, as described above in connection with FIGS. 4-10. In some aspects, the one or more sTTIs are determined based at least in part on a pattern associated with the uplink-downlink TDD sTTI configuration, as described above in connection with FIGS. 4-10.

Process 1200 may include additional aspects, such as any single aspect or any combination of aspects described below.

In some aspects, the pattern is determined based at least in part on the initial sTTI. In some aspects, the pattern is determined based at least in part on channel quality information. In some aspects, the pattern is indicated in at least one of: a radio resource control (RRC) configuration message, downlink control information (DCI), or some combination thereof. In some aspects, the pattern is determined based at least in part on a number of repetitions associated with the initial communication. In some aspects, the number of repetitions is indicated in downlink control information.

In some aspects, the pattern permits satisfaction of at least one of a latency requirement or a reliability requirement. In some aspects, the uplink-downlink TDD sTTI configuration includes: a threshold number of repetition opportunities, an sTTI allocation that permits a retransmission timing that satisfies a threshold, or some combination thereof. In some aspects, a final repetition, of the at least one repetition or retransmission of the initial communication, satisfies a specified timing for transmission of acknowledgement or negative acknowledgement (ACK/NACK) feedback corresponding to the final repetition.

In some aspects, the pattern includes one or more repetitions and no retransmissions. In some aspects, the pattern includes the one or more repetitions and no retransmissions when the uplink-downlink TDD sTTI configuration does not permit a retransmission timing that satisfies at least one of a latency requirement or a reliability requirement.

In some aspects, the pattern includes one or more retransmissions and no repetitions. In some aspects, the pattern includes the one or more retransmissions and no repetitions when the uplink-downlink TDD sTTI configuration includes a threshold number of opportunities for transmission of acknowledgement or negative acknowledgement (ACK/NACK) feedback and corresponding retransmissions.

In some aspects, the pattern includes one or more repetitions and one or more retransmissions. In some aspects, the pattern includes the one or more repetitions and the one or more retransmissions when a number of opportunities for transmission of acknowledgement or negative acknowledgement (ACK/NACK) feedback and corresponding retransmissions satisfies a first threshold but does not satisfy a second threshold.

In some aspects, the pattern includes a retransmission followed by one or more repetitions. In some aspects, a number of the one or more repetitions is determined based at least in part on channel quality information reported in connection with transmission of a negative acknowledgement (NACK) corresponding to the initial communication.

In some aspects, the pattern includes one or more repetitions followed by one or more retransmissions. In some aspects, channel quality information is reported in connection with transmission of a negative acknowledgement (NACK) corresponding to a final repetition of the one or more repetitions. In some aspects, the one or more retransmissions are followed by one or more additional repetitions, wherein a number of the one or more additional repetitions is determined based at least in part on the channel quality information.

In some aspects, the pattern is determined based at least in part on a determination of one or more anchor sTTIs or one or more non-anchor sTTIs associated with enhanced interference mitigation and traffic adaptation. In some aspects, the pattern permits satisfaction of a latency requirement relating to a particular number of sTTIs. In some aspects, the transmitting device is operating in an ultra-reliable low latency communication (URLLC) mode, and wherein the pattern permits satisfaction of a URLLC requirement. In some aspects, the transmitting device is a user equipment. In some aspects, the transmitting device is a base station. In some aspects, the uplink-downlink TDD sTTI configuration is based at least in part on an uplink-downlink TDD subframe configuration of a carrier associated with the uplink-downlink TDD sTTI configuration.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software.

Some aspects are described herein in connection with thresholds. As used herein, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods, described herein, may be implemented in different forms of hardware, firmware, or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

Even though particular combinations of features are recited in the claims and/or disclosed in the specification, these combinations are not intended to limit the disclosure of possible aspects. In fact, many of these features may be combined in ways not specifically recited in the claims and/or disclosed in the specification. Although each dependent claim listed below may directly depend on only one claim, the disclosure of possible aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the term “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

What is claimed is:

1. A method of wireless communication performed by a receiving device operating in a low latency mode or a high reliability mode, comprising:
determining an uplink-downlink time division duplex (TDD) shortened transmission time interval (sTTI) configuration;
determining an initial sTTI, within the uplink-downlink TDD sTTI configuration, for reception of an initial communication; and
monitoring one or more sTTIs, subsequent to the initial sTTI, for reception of at least one repetition or retransmission of the initial communication, wherein the one or more sTTIs are determined based at least in part on a pattern associated with the uplink-downlink TDD sTTI configuration.

2. The method of claim 1, wherein the pattern is determined based at least in part on the initial sTTI or channel quality information.

3. The method of claim 1, wherein the pattern is indicated in at least one of:
a radio resource control (RRC) configuration message,
downlink control information (DCI), or
some combination thereof.

4. The method of claim 1, wherein the pattern is determined based at least in part on a number of repetitions associated with the initial communication.

5. The method of claim 4, wherein the number of repetitions is indicated in downlink control information.

6. The method of claim 1, wherein the pattern permits satisfaction of at least one of a latency requirement or a reliability requirement.

7. The method of claim 1, wherein the uplink-downlink TDD sTTI configuration includes:
a threshold number of repetition opportunities,
an sTTI allocation that permits a retransmission timing that satisfies a threshold, or
some combination thereof.

8. The method of claim 1, wherein a final repetition, of the at least one repetition or retransmission of the initial communication, satisfies a specified timing for transmission of acknowledgement or negative acknowledgement (ACK/NACK) feedback corresponding to the final repetition.

9. The method of claim 1, wherein the pattern includes one or more repetitions and no retransmissions.

10. The method of claim 9, wherein the pattern includes the one or more repetitions and no retransmissions when the uplink-downlink TDD sTTI configuration does not permit a retransmission timing that satisfies at least one of a latency requirement or a reliability requirement.

11. The method of claim 1, wherein the pattern includes one or more retransmissions and no repetitions.

12. The method of claim 11, wherein the pattern includes the one or more retransmissions and no repetitions when the uplink-downlink TDD sTTI configuration includes a threshold number of opportunities for transmission of acknowledgement or negative acknowledgement (ACK/NACK) feedback and corresponding retransmissions.

13. The method of claim 1, wherein the pattern includes one or more repetitions and one or more retransmissions.

14. The method of claim 13, wherein the pattern includes the one or more repetitions and the one or more retransmissions when a number of opportunities for transmission of acknowledgement or negative acknowledgement (ACK/NACK) feedback and corresponding retransmissions satisfies a first threshold but does not satisfy a second threshold.

15. The method of claim 1, wherein the pattern includes a retransmission followed by one or more repetitions.

16. The method of claim 15, wherein a number of the one or more repetitions is determined based at least in part on channel quality information reported by the receiving device in connection with transmission of a negative acknowledgement (NACK) corresponding to the initial communication.

17. The method of claim 1, wherein the pattern includes one or more repetitions followed by one or more retransmissions.

18. The method of claim 17, wherein channel quality information is reported by the receiving device in connection with transmission of a negative acknowledgement (NACK) corresponding to a final repetition of the one or more repetitions.

19. The method of claim 18, wherein the one or more retransmissions are followed by one or more additional repetitions, wherein a number of the one or more additional repetitions is determined based at least in part on the channel quality information reported by the receiving device.

20. The method of claim 1, wherein the receiving device is a user equipment or a base station.

21. A method of wireless communication performed by a transmitting device operating in a low latency mode or a high reliability mode, comprising:
determining an uplink-downlink time division duplex (TDD) shortened transmission time interval (sTTI) configuration;
determining an initial sTTI, within the uplink-downlink TDD sTTI configuration, for transmission of an initial communication; and
transmitting at least one repetition or retransmission of the initial communication in one or more sTTIs subsequent to the initial sTTI, wherein the one or more sTTIs are determined based at least in part on a pattern associated with the uplink-downlink TDD sTTI configuration.

22. The method of claim 21, wherein the pattern is determined based at least in part on the initial sTTI or channel quality information.

23. The method of claim 21, wherein the pattern is indicated in at least one of:
a radio resource control (RRC) configuration message,
downlink control information (DCI), or
some combination thereof.

24. The method of claim 21, wherein the pattern is determined based at least in part on a number of repetitions associated with the initial communication.

25. The method of claim 21, wherein the uplink-downlink TDD sTTI configuration includes:
a threshold number of repetition opportunities,
an sTTI allocation that permits a retransmission timing that satisfies a threshold, or
some combination thereof.

26. The method of claim 21, wherein a final repetition, of the at least one repetition or retransmission of the initial communication, satisfies a specified timing for transmission of acknowledgement or negative acknowledgement (ACK/NACK) feedback corresponding to the final repetition.

27. The method of claim 21, wherein the pattern includes at least one of:
one or more repetitions and no retransmissions,
one or more retransmissions and no repetitions,
one or more repetitions and one or more retransmissions,
a retransmission followed by one or more repetitions, or
one or more repetitions followed by one or more retransmissions.

28. The method of claim 27, wherein:
the pattern includes the one or more repetitions and no retransmissions when the uplink-downlink TDD sTTI configuration does not permit a retransmission timing that satisfies at least one of a latency requirement or a reliability requirement,
the pattern includes the one or more retransmissions and no repetitions when the uplink-downlink TDD sTTI configuration includes a threshold number of opportunities for transmission of acknowledgement or negative acknowledgement (ACK/NACK) feedback and corresponding retransmissions, or
the pattern includes the one or more repetitions and the one or more retransmissions when a number of opportunities for transmission of ACK/NACK feedback and corresponding retransmissions satisfies a first threshold but does not satisfy a second threshold.

29. The method of claim 21, wherein a number of the at least one repetition is determined based at least in part on channel quality information reported in connection with transmission of a negative acknowledgement (NACK) corresponding to the initial communication.

30. The method of claim 21, wherein channel quality information is reported in connection with transmission of a negative acknowledgement (NACK) corresponding to a final repetition of the at least one repetition.

31. The method of claim 21, wherein the transmitting device is a user equipment or a base station.

32. A receiving device for wireless communication, comprising:
memory; and
one or more processors coupled to the memory, the memory and the one or more processors configured to:
determine an uplink-downlink time division duplex (TDD) shortened transmission time interval (sTTI) configuration;
determine an initial sTTI, within the uplink-downlink TDD sTTI configuration, for reception of an initial communication; and
monitor one or more sTTIs, subsequent to the initial sTTI, for reception of at least one repetition or retransmission of the initial communication, wherein the one or more sTTIs are determined based at least in part on a pattern associated with the uplink-downlink TDD sTTI configuration.

33. The receiving device of claim 32, wherein the pattern is determined based at least in part on the initial sTTI or channel quality information.

34. The receiving device of claim 32, wherein the pattern is indicated in at least one of:
a radio resource control (RRC) configuration message,
downlink control information (DCI), or
some combination thereof.

35. The receiving device of claim 32, wherein the pattern is determined based at least in part on a number of repetitions associated with the initial communication.

36. The receiving device of claim 32, wherein a final repetition, of the at least one repetition or retransmission of the initial communication, satisfies a specified timing for transmission of acknowledgement or negative acknowledgement (ACK/NACK) feedback corresponding to the final repetition.

37. A transmitting device for wireless communication, comprising:
memory; and
one or more processors coupled to the memory, the memory and the one or more processors configured to:
determine an uplink-downlink time division duplex (TDD) shortened transmission time interval (sTTI) configuration;
determine an initial sTTI, within the uplink-downlink TDD sTTI configuration, for transmission of an initial communication; and
transmit at least one repetition or retransmission of the initial communication in one or more sTTIs subsequent to the initial sTTI, wherein the one or more sTTIs are determined based at least in part on a pattern associated with the uplink-downlink TDD sTTI configuration.

38. The transmitting device of claim 37, wherein the pattern is determined based at least in part on the initial sTTI or channel quality information.

39. The transmitting device of claim 37, wherein the pattern is indicated in at least one of:
a radio resource control (RRC) configuration message,
downlink control information (DCI), or
some combination thereof.

40. The transmitting device of claim 37, wherein the pattern is determined based at least in part on a number of repetitions associated with the initial communication.

41. The transmitting device of claim 37, wherein a final repetition, of the at least one repetition or retransmission of the initial communication, satisfies a specified timing for transmission of acknowledgement or negative acknowledgement (ACK/NACK) feedback corresponding to the final repetition.
